(19) United States
(12) Patent Application Publication
(10) Pub. No.: US 2012/0082759 A1
(43) Pub. Date: Apr. 5, 2012

(54) Compositions and methods for mycotoxin decontamination, nucleotide, protein and vitamin enrichment and palatability enhancement of food and animal feed using micronized yeast biomass

(75) Inventors: Dennis Theodore Tranquil, Jupiter, FL (US); Elizabeth Tranquil, Jupiter, FL (US)

(73) Assignee: CUBENA, INC., Jupiter, FL (US)

(21) Appl. No.: 13/248,522

(22) Filed: Sep. 29, 2011

Related U.S. Application Data
(60) Provisional application No. 61/388,860, filed on Oct. 1, 2010.

(51) Int. Cl. A23L 1/30; A23L 1/305; A23K 1/16; A23L 1/302

(52) U.S. Cl. 426/62

(57) ABSTRACT

A method for upgrading human food and animal feed, rendering harmless the contaminating mycotoxins, increasing protein and nucleotide content, providing immuno-modulation, enhancing flavor and palatability is proposed. The method comprises a food functional additive/supplement and feed additive based on yeast biomass processed to enhance the bioavailability and biological activity of its components using dry micron milling with optional agglomeration. The resulting product contains all biologically active components originally present in intact live yeast. Compared to existing practice, the new process is much faster, cheaper, less hardware demanding, less prone to microbial contamination, provides intact biopolymers and results in insoluble product fraction with high surface area. Human food and animal feed containing such additive improves weight gains, feed efficiency, resilience to mycotoxin contamination, improves immunological status, controls intestinal Salmonella and other bacteria and decreases mortality, especially at the young age, replacing antibiotics and growth promoters.

### FIELD OF THE INVENTION

The present invention addresses the problem of supplementation of food and feed with functional additives, provides decontamination from mycotoxins and intestinal harmful bacteria, boosts immunological status, improves palatability and taste is a source of additional protein, vitamins and nucleotides. As a result, through such upgrade, human food is enriched and made safer and the performance and wellbeing of agricultural and companion animals are significantly improved.

### BACKGROUND OF THE INVENTION

Yeast biomass and its components have been known as valuable additives in human and animal nutrition. Currently yeast biomass is separated into components by wet techniques. Yeast extract is separated from cell wall fraction first. Yeast extract is known to be a source of high-value proteins, nucleotides and vitamins, especially of the B group. Yeast extract is widely used as a flavoring agent in food industry and a source of purified “umami” nucleotides. In animal feed the nucleotide supplementation of feed improves weight gains on young animals (U.S. Pat. No. 6,777,396). Minimal requirements for nucleotide nutrition have been formulated for each type of agricultural animal to calculate the necessary supplementation (U.S. Pat. No. 6,658,308 followed by U.S. Pat. No. 7,418,303). The benefit of nucleotide supplementation in form of yeast extract has been demonstrated, for example in horse feed (U.S. Pat. No. 7,658,964).

In turn, cell wall can be separated into beta-glucan, in charge of mycotoxin binding, and mannan, in charge of Salmonella binding and immuno-modulation, producing two distinct lines of products.

Yeast beta-glucans activate macrophages and have profound effects on the synthesis and levels of many cytokines, which in turn are responsible for immuno modulation (2). Yeast cell wall polysaccharides were also shown to bind Salmonella and other pathogenic bacteria during animal and human digestion (U.S. Pat. No. 6,387,420).

Separation of yeast biomass components has a number of times been shown to yield more biologically active feed additives compared to an equivalent amount of unprocessed yeast. For example, U.S. Pat. No. 6,045,834 (Compositions and methods for removal of mycotoxins from animal feed, 2000) demonstrates that yeast cell wall adsorbs mycotoxins better than yeast biomass. U.S. Pat. No. 6,214,337 shows that the efficiency of yeast glucan in promoting weight gains on pigs is higher than that of yeast cell wall. In turn, the efficiency of yeast cell wall is higher than that of yeast cells.

However, the separation process is expensive, implies extraction, cascade centrifugation and spray-drying. Due to process inconsistencies the immuno-modulating benefits of the product are not always pronounced, while the Quality Control protocols necessary to evaluate this property are complicated. At each step of wet processing there is a risk of microbial contamination, adding to the complexity and cost of the hardware and process. As a result, there is a significant price increase per kg from yeast biomass and yeast biomass separated into its components.

Therefore, a simplified and streamlined method of processing yeast biomass yielding biologically active fractions beneficial as food and feed additives would be highly advantageous commercially.

### SUMMARY OF THE INVENTION

A primary object of the present invention is to provide a method for supplementing food and animal feed with an inexpensive yeast biomass-based additive providing deactivation of mycotoxins, immuno-modulation, control of Salmonella, protein, vitamin and nucleotide enrichment and, as a result, improvement in human and agricultural and companion animal wellbeing and performance.

The method comprises the use of specially treated biomass of yeast. The biomass is subjected to dry milling or micronization using special techniques and equipment providing particles of the average final size between 5 and 20 microns without substantial degradation of the product properties due to overheating, oxidation or wet decomposition.

The resulting micron-milled particles can be subjected to optional aggregation into micro-granules using methods known in the art, to provide wider compatibility of the product with food and feed processing equipment.

As a result, the biomass after milling, due to its small particle size, and high surface area, disintegration of cells and bearing the surface of each biomass component separately provides physiological action on humans, domestic and companion animals and aquaculture specie that is until now can be achieved only after cumbersome fractionation of yeast biomass using wet processing methods, such as cell lysis, centrifugation, pasteurization, solvent extraction and spay drying.

In short, the yeast biomass micronized in a dry state has the same biological action and effectiveness as a mixture of purified yeast components until now available only as products of expensive wet fractionation.

The resulting composition provides a number of benefits as a functional food and feed additive. The beta-glucan and chitin fractions of the cell wall deactivate mycotoxins present in feed by binding. The cell wall mannan fraction provides immune modulation and Salmonella binding, while the interior content of the yeast cell serves as a source of highly available proteins, vitamins and nucleotides. Both protein and nucleotide boosting are essential for the wellbeing and performance of young and breeding animals, including aquaculture species.

### DETAILED DESCRIPTION OF THE INVENTION

The present invention is based upon the discovery that the dry yeast biomass material can processed by micron milling (micronization) into a sum of cell components that until now were only effective and available after yeast biomass separation using complicated wet processes.

The yeast biomass components when isolated have shown benefits in animal and human nutrition that exceed the benefits of equivalent dosages of untreated yeast biomass. The micron milling (micronization) of dry yeast biomass performed according to the present invention makes it possible to produce yeast biomass material with the same strong biological action as purified biomass components produced using extensive wet fractionation—yeast extract, cell wall glucan and cell wall mannan—mixed back together.

The capacity of the yeast biomass for all the purposes enumerated above can be further improved using selected yeast strains and species and fermentation conditions. For example, yeast strains with abnormal cell wall morphology and shape can be selected or generated through mutagenesis. To achieve maximal nucleotide content, the fermentation is conducted at the exponential growth phase with maximal air or oxygen supplementation. To provide the highest mycotoxin binding capacity, yeast are grown in conditions generating thick cell walls, for example in the presence of abundant vitamin source, such as DDG. Another approach is to use for yeast cultivation an insoluble substrate, which is known to express mycotoxin binding properties by itself.

The biomass can be derived either from a mainstream industrial yeast fermentation, typically performed by a third party for its own purposes, such as, but not limited to: production of fuel ethanol, potable alcohol, spirits, beer, pharmaceuticals, nutraceuticals, pigments. Alternatively, the biomass of interest can be derived from a dedicated in-house fermentation, specifically targeting the biosynthesis of mycotoxin-binding agents, immuno-modulators, Salmonella binders, protein, vitamin and nucleotide supplements as primary products.

In the preferred embodiment of the invention the yeast biomass in harvested from a submerged fermentation of Saccharomyces cerevisiae using DDG or wheat bran as a substrate. After the fermentation the yeast biomass with residual substrate is collected and dried.

To achieve such micron milling without charring the material, special techniques are used. These minimize the ratio between the milling energy absorbed as heat by the material (damage) and milling energy actually used to create additional surface area (benefit). The damage to benefit ratio is minimized by optimizing the collision speed between the particles and between the particles and the milling surfaces, as well as optimizing the geometry of particle travel inside the milling chamber. Typically a speed of not less than 150 m/sec is required, for what an orbital mill is used, either with a classifier or without.

In addition, the generated surface area of the fine particles can be stabilized by co-milling yeast biomass with agents that can serve as particle separators, such as silica, talck, lignin or zeolite. Other separation additives known in the art, such as anti-caking agents can be also used.

Additional objects, advantages and other novel features of the invention will be set forth in part in the description that follows and in part will become apparent to those skilled in the art upon examination of the following or may be learned with the practice of the invention. The objects and advantages of the invention may be realized and obtained by means of the instrumentalities and combinations particularly pointed out in the appended claims.

The resulting micron-milled powder can be optionally agglomerated into micro-granules 40-1000 microns in size, to ensure compatibility with a wider range of food and feed processing equipment, including pneumatic powder transportation systems. Agglomeration can be performed with further supplementing the composition by biologically active ingredients known in the art, such as vitamins, amino acids and their analogues, enzymes, pharmaceuticals, immune bodies and other immune modulators, hepatic protectors, anti-oxidants, including Selenium based ones, pigments, acidifiers, micro-elements, including chelated version, flavors, dispersants and surface agents, and by processing aids known in the art, such as binders, granule strength enforcers, granule dissolution accelerators, granule surface coating components, etc. Agglomeration can be performed using traditional Glatt-type reactors for applying liquid components during granule formation is fluid bed layer, or using an extruder, or using a pellet press. The preferred embodiment of the invention will use a mixing reactor with high shear stress, known in the art.

As a result and in accordance with the purposes of the present invention as described herein, a novel method is proposed for achieving a number of benefits in human and animal nutrition. These benefits include, but are not limited to: binding mycotoxins present, modulating the immune status, controlling infectious bacteria in digestive tract, providing protein, vitamin and nucleotide nutrition and respective improvements in wellbeing, health and performance, improvement and modification of flavor and palatability.

The micronized and optionally agglomerated biomass of yeast becomes the core ingredient and can be once again combined with other functional components, both proprietary and non-proprietary, such as acidifiers, other mycotoxin binding solutions, energy boosters, hepatic protectors, vitamins, dispersants, probiotics, prebiotics, enzymes, etc., in a supplement delivering expanded benefits.

In a preferred embodiment, the food or feed additive composition of the present invention comprises between about 10% and 100% of the component based on micronized yeast biomass, and between 0% and about 10% of other functional components. A preferred composition of the invention comprises from between about 25% to about 75% of component based on micronized yeast biomass, and between about 75% and about 50% of other functional components. An especially preferred embodiment of the invention comprises from between about 70% to about 50% of micronized yeast biomass, and between about 30% and about 50% of other functional component. The preferred physical form of the invention is a dry, free-flowing non-dusting powder or micro-granulate suitable for direct inclusion into dry food, animal feed premixes or as a supplement to a total mixed ration.

The composition can be added to any human food, dry, powder, formed, paste, jelly or liquid or used as a functional nutritional supplement in the form of powder, tablets, paste or suspension, with or without other ingredients. When admixed with food or fed as a supplement, the compositions, with their substantially enhanced functional properties as discussed above, significantly improve performance, wellbeing and health.

The compositions provided by the present invention can be added to any commercially available feedstuffs for livestock or companion animals including, but not limited to, premixes, concentrates and pelleted concentrates. The composition provided by the present invention may be incorporated directly into commercially available mashed and pelleted feeds or fed supplementally to commercially available feeds. When incorporated directly into animal feeds, the present invention may be added to such feeds in amounts ranging from 0.2 to about 5 kilograms per ton of feed. In a preferred composition, the invention is added to feeds in amounts ranging from 0.5 to about 2 kilograms per ton of feed. In an especially preferred composition, the invention is added to feeds in amounts ranging from 1 to 2 kilograms per ton of feed. The composition contained in the present invention may be fed to any animal, including but not limited to, aquaculture, avian, bovine, porcine, equine, ovine, caprine, canine, and feline species.

Alternatively, the composition contained in the present invention may be directly fed to animals as a supplement in amounts ranging from 2.0 to 20 grams per animal per day. An especially preferred embodiment comprises feeding the composition contained in the present invention to animals in amounts ranging from 5 to 15 grams per animal per day, depending on the animal species, size of the animal and the type of feedstuff to which the composition is to be added.

### EXAMPLES

The following examples are intended to be illustrative of the invention, and are not to be considered restrictive of the scope of the invention as otherwise described herein.

### Example 1

To compare the effectiveness of the micronized yeast biomass as a mycotoxin binder versus existing commercial products, an in-vitro mycotoxin binding assay was established. Conditions include adsorption of four mycotoxins typical for North American and European markets—deoxynivalenol (=DON, vomitoxin), ochratoxin (OTA), T-2 toxin and zearalenone (ZEN)—from an aqueous solution, pH 6.5 (0.1 M Na-phosphate buffer), at 37° C. within an hour by 0.5% suspension of the adsorbent candidate. Concentration of each mycotoxin in the mix has been chosen at 1 mg/l (in sum −4.0 mg/l).

Mycotoxin content in the model aqueous solution was measured using HPLC/MS/MS on a C-8 column eluted by a gradient of formiate buffer->acetonitrile. Under these HPLC conditions mycotoxins are eluted in the following sequence: DON-OTA-T-2-ZEN

### Example 2

The biomass of Saccharomyces cerevisiae was produced by submerged fermentation on wheat bran under standard industrial conditions and dried. The dried material was micronized to 5 microns using an orbital mill. The material was tested in-vitro for its mycotoxin binding properties in comparison to the commercial mycotoxin binder Mycosorb (Alltech, Ky.), based on esterified yeast beta-glucan, and yeast/bacterial biomass-based binder Mycofix Plus (Biomin, Austria) using the protocol described in Example 1. The effectiveness of binding four mycotoxins is presented in Table 1.

TABLE 1
In-vitro effectiveness of adsorption of four mycotoxins by two
commercial binders and three variants of micronized yeast biomass,
alone and in combination with acid hydrolysis lignin.

| | % of mycotoxin adsorbed from a | | | |
|---|---|---|---|---|
| Adsorbent candidate, 5 g/l, | mixture of 4 toxins, 1 mg/l each | | | |
| pH 6.5, 37° C., 1 hour | DON | OTA | T-2 | ZEA |
| Commercial mycotoxin binders | | | | |
| Mycosorb (Alltech, Ireland) | 55.3 | 16.1 | 6.1 | 62.7 |
| Mycofix Plus (Biomin, Austria) | 4.8 | 0.1 | 17.2 | 42.9 |
| Yeast-based mycotoxin binding | | | | |
| candidates | | | | |
| Yeast, Saccharomyces cerevisiae, | 46.7 | 7.0 | 7.4 | 57.6 |
| grown on wheat bran, micronized | | | | |
| to 5 mkm | | | | |
| Yeast, Saccharomyces cerevisiae, | 48.9 | 7.7 | 2.5 | 67.9 |
| grown on distiller's grain, | | | | |
| impeller-miled to 20 mkm | | | | |
| 40% wheat bran yeast + 60% lignin, | 36.5 | 21.6 | 23.7 | 93.8 |
| co-micronized to 5 mkm | | | | |

### Example 3

The biomass of Saccharomyces cerevisiae was produced by submerged fermentation on wet distiller's grain under standard industrial conditions and dried. The dried material was milled to 10-30 microns using an impeller mill with the following specifications:

| Number of rotors | 1 | |
|---|---|---|
| Position of rotors | horizontal | |
| Rotation frequency | 4,500 | rpm |
| Linear speed of collision | 70 | m/sec |
| Electrical power consumption | 30 | kW |
| Milling capacity | 120 | kg/hour |
| Maximal start particle size | 20 | mm |

| | |
|---|---|
| Maximal hardness of start material, Mohs scale | 3 |

The material was tested for its mycotoxin binding properties in comparison to the commercial yeast esterified beta-glucan based binder Mycosorb (Alltech, Kentucky) and yeast/bacterial biomass based binder Mycofix Plus (Biomin, Austria) in-vitro using the protocol described in Example 1. The effectiveness of initial binding is presented in Table 1.

### Example 4

The biomass of Saccharomyces cerevisiae was obtained as described in Example 2. Acid hydrolysis lignin was obtained from a dedicated landfill, approximately 10 years old, established by the Kirov hydrolysis plant, Vyatka Region, Russia. Lignin was dried and simultaneously milled in a natural gas-heated fluid bed drier with exit temperature of 60° C., supplied with a hammer mill and classifier to approximately 100 microns and 8% moisture content. The dried yeast and dried lignin were pre-mixed at 40:60 w/w proportion and co-micronized to 5 microns using the orbital mill, same as in Example 2. The material was tested for its mycotoxin binding properties in comparison to the commercial yeast esterified beta-glucan based binder Mycosorb (Alltech, Kentucky) and yeast/bacterial biomass based binder Mycofix Plus (Biomin, Austria) using the protocol described in Example 1. The effectiveness of initial binding is presented in Table 1.

### Example 5

Biomass of Saccharomyces cerevisiae was obtained by a milling dry fodder yeast on an impeller mill. Acid hydrolysis lignin was produced, as described in Example 4. Yeast was mixed with lignin in 70:30 proportion and agglomerated using a high sheer mixing reactor. A 40% solution of low molecular weight Malto-dextrin M-180 (a product of partial hydrolysis of starch by alpha-amylase enzyme) in hot water was used at various loads as a binding agent. Agglomeration process was conducted for 5 mines at room temperature. The agglomerated samples were dried up in an oven at 80° C. for 120 minutes. For the agglomerated versions of the product the following parameters were taken: Malto-dextrin inclusion into the end-product (w/w, calculated), final moisture content and bulk density (using standard methods) and size distribution of the agglomerated microgranules (using Air-Jet analysis). Results of pilot agglomerations trials using various inclusion of the binding agent (Malto-dextrin M180) are presented in Table 2.

TABLE 2
Size distribution, final moisture content and bulk density after agglomeration and drying of
a mix of yeast and lignin, depending on inclusion of the binding agent (Malto-dextrin M180).

| | | Initial | Initial | | | | | | | |
|---|---|---|---|---|---|---|---|---|---|---|
| | | Yeast | Lignin | 70% Yeast + 30% Lignin | | | | | | |
| Final maltodextin, | | — | . | 0% (water | 3.00% | 3.24% | 7.73% | 8.91% | 12.13% | 15.21% |
| w/w | | | | only) | | | | | | |
| Volatiles before | | . | — | 31.76% | 10.55% | 10.79% | 17.73% | 19.19% | — | 27.18% |
| drying, w/w | | | | | | | | | | |
| Cummulative | 1680 | | | — | — | — | — | — | — | 0.1% |
| weight of the | 1190 | | | — | — | — | — | — | — | 0.8% |
| fraction with | 1000 | | | — | — | — | — | — | — | 1.8% |
| particle size | 841 | | | — | 0.3% | — | 1.3% | 1.7% | 1.3% | 3.8% |
| above, mkm | 420 | 2.70% | | 2.5% | — | 4.7% | 7.4% | 9.9% | 14.6% | 37.8% |
| | 210 | 18.00% | | 14.7% | 14.9% | 18.9% | 29.6% | 40.1% | 52.4% | 91.9% |
| | 105 | 42.50% | | 34.8% | 36.1% | 38.4% | 58.5% | 69.1% | 84.4% | 99.5% |
| | 74 | 53.80% | 0.60% | 44.6% | 46.8% | 47.5% | 70.8% | 78.6% | 93.2% | 99.9% |
| | 37 | 77.80% | 1.80% | 64.1% | 62.2% | 60.5% | 84.9% | 89.9% | 100.0% | 100.0% |

| | | | | | | | | | |
|---|---|---|---|---|---|---|---|---|---|
| Loose bulk density, | . | . | 0.31 | 0.37 | 0.39 | 0.44 | 0.41 | 0.42 | 0.43 |
| wet, g/mL | | | | | | | | | |
| Loose Bulk Density, | 0.35 | 0.25 | 0.37 | 0.42 | 0.41 | 0.45 | 0.44 | 0.5 | 0.51 |
| dry, g/mL | | | | | | | | | |
| Moisture, wet, % | . | — | 29.62 | 11.03 | 10.49 | 17.32 | 18.59 | 22.85 | 26.66 |
| Moisture after | 6.83 | 8.89 | 1.73 | 0.65 | 0.63 | 0.94 | 0.8 | 1.07 | 0.92 |
| drying, % | | | | | | | | | |

What is claimed is:

1. A composition useful for: adsorbing and thereby rendering harmless in food and animal feed a wide spectrum of mycotoxins, boosting immune response, binding harmful intestinal bacteria, providing additional protein, vitamin and nucleotide food and feed supplementation, improving palatability, modifying flavor and taste, comprising 10-100% of yeast biomass milled or micronized in a dry state to 3-20 microns particle size and optionally agglomerated into 40-1000 microns microgranules, where yeast belong to the genus such as, but not limited to: Saccharomyces, Klyoveromyces, Candida and Torula, and are produced either as by-product of yeast fermentation or in dedicated processes, the milling or micronization step is conducted under optimized conditions, allowing most of the energy applied in the milling process to be converted into formation of new surface area instead of heat generation and the agglomerated step is conducted in a designated reactor, such as, but not limited to continuous high shear mixing reactor.

2. Method of supplementation of food, when the effective amount of the micronized and optionally agglomerated yeast biomass-based composition is added to any human food, dry, powder, formed, paste, jelly or liquid or used as a functional nutritional supplement in the form of powder, tablets, paste or suspension, with or without other biologically active or process-aiding ingredients, rendering harmless a wide spectrum of mycotoxins, boosting immune response, binding harmful intestinal bacteria, providing additional protein, vitamin and nucleotide supplementation, improving palatability and modifying flavor and taste.

3. Method of supplementation of animal feed intended for agricultural or companion animals belonging to the group of invertebrate and vertebrate aquatic, avian and mammalian (such as bovine, porcine, equine, ovine, caprine, canine, feline) species, when the effective amount of the micronized yeast biomass based composition comprises from between about 0.02% to between about 0.5% by weight of the animal's daily feed ration, rendering harmless a wide spectrum of mycotoxins, boosting immune response, binding harmful intestinal bacteria, providing additional protein, vitamin and nucleotide supplementation, improving palatability and modifying flavor and taste.
